(19) United States
(12) Patent Application Publication
(10) Pub. No.: US 2009/0182557 A1
(43) Pub. Date: Jul. 16, 2009

(54) SOUND/VOICE PROCESSING APPARATUS, SOUND/VOICE PROCESSING METHOD, AND SOUND/VOICE PROCESSING PROGRAM

(75) Inventors: Youhei Yabuta, Iwaki-city (JP); Toru Marumoto, Iwaki-city (JP); Nozomu Saito, Iwaki-city (JP)

Correspondence Address: ALPINE/BHGL, P.O. Box 10395, Chicago, IL, 60610, US

(73) Assignee: Alpine Electronics, Inc., Shinagawa-ku (JP)

(21) Appl. No.: 12/350,401

(22) Filed: Jan. 8, 2009

(30) Foreign Application Priority Data
Jan. 10, 2008 (JP) 2008-003070

(51) Int. Cl. G10L 19/14; G10L 19/00

(52) U.S. Cl. 704/211; 704/201; 704/E19.001

(57) ABSTRACT

If a delay occurs in execution of sound/voice processing application software, and, as a result, MIC data is stored in a plurality of buffers, then a CPU identifies, based on a buffer list, a buffer in which newest MIC data is stored. The CPU reads the newest MIC data from the identified buffer and adjusts an output sound/voice level depending on an external sound/voice level, using the newest MIC data.

### RELATED APPLICATIONS

The present application claims priority to Japanese Patent Application Number 2008-003070, filed Jan. 10, 2008, the entirety of which is hereby incorporated by reference.

### FIELD OF THE INVENTION

The present invention relates to a sound/voice processing apparatus configured to process voices/sounds in an apparatus having an audio function, a sound/voice processing method, and a sound/voice processing program executed by a computer serving as the sound/voice processing apparatus.

### DESCRIPTION OF RELATED ART

In an apparatus (sound/voice processing apparatus) configured to perform various kinds of processes, such as speech recognition (SR), sound/voice recording, etc., based on an external sound/voice, data of the external sound/voice (MIC data) detected by a microphone is sequentially processed by application software (see, for example, Japanese Unexamined Patent Application Publication No. 11-166835).

FIG. 18 is a sequence diagram illustrating an example of sound/voice processing. When a resource of a CPU in the sound/voice processing apparatus is assigned to sound/voice processing application software (hereinafter referred to simply as sound/voice processing software), the sound/voice processing software is executed by the CPU. By executing the sound/voice processing software, the CPU detects a plurality of empty buffers of buffers provided in the sound/voice processing apparatus and assigns the detected empty buffers as storage areas for storing MIC data (step S501), and the CPU requests the sound driver (SD) to register the detected empty buffers in a queue (step S502). The CPU executes the sound driver to prepare a queue in which to put empty buffers and sequentially register the empty buffers in the queue in accordance with the registration request (step S503).

When a general-purpose CPU is used to perform a plurality of processes corresponding to different pieces of application software, nothing is guaranteed as to the assignment of the resource of the CPU to the processes and as to intervals at which the resource is assigned. In general, execution of processes is controlled in accordance with predetermined priority. When a process is being processed, if an interrupt request for a process with higher priority occurs, the execution is switched, and the process with the lower priority is not performed during the execution of the process with the higher priority. Therefore, if a process of the sound/voice processing software is assigned low priority, the resource of the CPU necessary to execute this process is not necessarily assigned and no empty buffers are registered in the queue over a period, which can be very long depending on the situation. In this case, the CPU cannot execute the sound driver to store MIC data produced from a microphone into a buffer, and thus an MIC data acquisition error occurs. To avoid the problem described above, the CPU executes the sound/voice processing software in step S502 described above to request the sound driver to register a plurality of empty buffers in the queue. In response, in step S503 described above, the sound driver registers the plurality of empty buffers in the queue.

Thereafter, by executing the sound/voice processing software, the CPU issues a record start command to the sound driver (step S504). Furthermore, the CPU executes the sound driver to input MIC data from a microphone in accordance with the command, and store the MIC data in empty buffers in the same order as the buffers are registered in the queue (step S505). More specifically, the MIC data is stored sequentially in empty buffers registered in the queue in the order in a direction from top to end of the queue. If the MIC data has been stored in the buffer, the CPU notifies the sound/voice processing software of the completion of storing the data in the buffer (store-in-buffer completion notification), by executing the sound driver (step S506).

If the store-in-buffer completion notification is issued, the CPU executes the sound/voice processing software to acquire the store-in-buffer completion notification and perform specified sound/voice processing using the MIC data stored in the buffers (step S507). The CPU then requests the sound driver to register the buffer storing the MIC data subjected to the process in S507 in the queue, by executing the sound/voice processing software (step S508). The CPU further executes the sound/voice processing software to request the sound driver to register the specified buffer at the end of the queue, in other words, to move the specified buffer from the top to the end of the queue (step S509). As a result, a buffer located next to the top of the queue is moved to the top of the queue. Thereafter, the process from step S505 to step S509 is performed repeatedly until the sound/voice storing process is completed.

Some audio apparatuses for use in vehicles are configured to detect a noise level in a vehicle and adjust the level of an output sound/voice such as a guidance sound/voice depending on the detected noise level so that the sound level perceived by a user is maintained constant.

In order to properly adjust the output sound/voice depending on the current acoustic environment in the vehicle in the above-described manner, it is necessary to use as new MIC data of noise as possible in the adjustment of the output sound/voice level so that the adjustment is performed in real time. However, in the conventional technique described above, there is a possibility that the resource of the CPU is assigned to the sound driver with higher priority and no resource of the CPU is assigned to the sound/voice processing software with lower priority, and thus there is a possibility that a delay occurs in the process performed by the sound/voice processing software using the MIC data although MIC data is sequentially stored in buffers registered in the queue via the execution of the sound driver. After the resource of the CPU is assigned to the sound/voice processing software, the MIC data is sequentially subjected to the process in the order from top to end of the quest, i.e., from oldest to newest.

In a case where a delay occurs in the process performed by the sound/voice processing software using the MIC data, the process is performed, for example, as follows. In a state shown in FIG. 19, an external sound/voice detected by a microphone 504 is converted by an analog-to-digital converter (ADC) 506 into MIC data in digital form, and the resultant digital MIC data is stored in first three buffers A to C of buffers A to E registered in a queue.

FIG. 20 is a sequence diagram illustrating a process of storing sound/voice data for a case where a delay occurs in the process using MIC data as in the case shown in FIG. 19. In the case where a delay occurs in the process using MIC data in the execution of the sound/voice processing software, and, as a result, MIC data is stored in the buffers A to C by execution of the sound driver, the CPU sends a notification of completion of storing data in a buffer to the sound/voice processing software each time MIC data is stored in one of the buffers by executing the sound driver (steps S511, S512, and S513).

Thereafter, if the resource of the CPU in the sound/voice processing apparatus is assigned to the sound/voice processing software, the CPU executes the sound/voice processing software to first acquire the notification of completion of storing data in a buffer A and then perform a predetermined sound/voice processing using the MIC data stored in the buffer A registered at the top of the queue (step S514). More specifically, as shown in FIG. 21, the past MIC data in the buffer A is accepted by an accepting unit of the sound/voice processing software and is processed by a processing unit.

Next, the CPU executes the sound/voice processing software to request the sound driver to re-register the buffer A, in which the MIC data subjected to the process in step S514 is stored, at the end of the queue (step S515). Furthermore, the CPU executes the sound driver to re-register the buffer A at the end of the queue according to the registration request, i.e., move the buffer A from the top of the queue to the end of the queue (step S516). As a result, a buffer B located next to the top of the queue comes to the top of the queue.

Next, the CPU executes the sound/voice processing software so as to acquire a notification of completion of storing data in the buffer B and perform the predetermined sound/voice processing using the MIC data stored in the buffer B registered at the top of the queue (step S5 17). More specifically, as shown in FIG. 22, the past MIC data in the buffer B is accepted by the accepting unit of the sound/voice processing software and is processed by the processing unit.

Next, the CPU 102 executes the sound/voice processing software to request the sound driver to re-register the buffer B in which the MIC data subjected to the process in step 5517 is stored at the end of the queue (step S518). Furthermore, the CPU executes the sound driver to re-register the buffer B at the end of the queue according to the registration request, i.e., move the buffer B from the top of the queue to the end of the queue (step S519). As a result, a buffer C located next to the top of the queue comes to the top of the queue.

Next, the CPU 102 executes the sound/voice processing software so as to acquire a notification of completion of storing data in the buffer C and then perform the predetermined sound/voice processing using the MIC data stored in the buffer C registered at the top of the queue (step S520). More specifically, as shown in FIG. 23, the past MIC data in the buffer C is accepted by the accepting unit of the sound/voice processing software and is processed by the processing unit.

Next, the CPU 102 executes the sound/voice processing software to request the sound driver to re-register the buffer C, in which the MIC data subjected to the process in step S520 is stored, at the end of the queue (step S521). Furthermore, the CPU executes the sound driver to re-register the buffer C at the end of the queue according to the registration request, i.e., move the buffer C from the top of the queue to the end of the queue (step S522).

As described above, the newest MIC data is not processed first because it is stored in the buffer C registered in the third position of the queue in the initial state. That is, the older MIC data stored in the buffers A and B is first processed before the newest MIC data stored in the buffer C is processed, and thus there occurs a delay corresponding to the time needed to perform the older MIC data stored in the buffers A and B. Therefore, it is not guaranteed that the adjustment of the output sound/voice is performed properly using the newest MIC data.

One technique to avoid the above-described problem is to use a digital signal processor (DSP) dedicated to the adjustment of the output sound/voice. However, use of the DSP results in an increase in cost.

### SUMMARY OF THE INVENTION

In view of the problems described above, it is an object of the present invention to provide a sound/voice processing apparatus and a sound/voice processing method for properly processing a sound/voice using external sound/voice data, and a sound/voice processing program executed by a computer operating as a sound/voice processing apparatus.

In one aspect, the present embodiments provide a sound/voice processing apparatus including a plurality of buffers, an external sound/voice detector configured to detect an external sound/voice, a storage processing unit configured to store data of the external sound/voice detected by the external sound/voice detector into an empty buffer of the plurality of buffers, an external sound/voice data reading unit configured to read external sound/voice data included in the external sound/voice data stored in the buffers by the storage processing unit, the external sound/voice data to be read being determined depending on a sound/voice adjustment process, such as depending on a current state or status of the sound/voice adjustment process, to be performed using the external sound/voice data, and an external sound/voice processing unit configured to perform the process using the external sound/voice data read by the external sound/voice data reading unit.

In this sound/voice processing apparatus, if a delay occurs in the sound/voice processing and, as a result, external sound/voice data is stored in a plurality of buffers, then external sound/voice data determined depending on the sound/voice processing, or a state or status thereof, is read and is subjected to the sound/voice processing using the external sound/voice data. Thus, the sound/voice processing is performed using correct external sound/voice data.

In the sound/voice processing apparatus according to the present embodiment, the external sound/voice data reading unit may read the newest, current, or most up-to-date external sound/voice data of the external sound/voice data stored in the buffers by the storage processing unit, and the external sound/voice processing unit may adjust an output sound/voice level based on the newest external sound/voice data read by the external sound/voice data reading unit.

In this implementation of the sound/voice processing apparatus, when the output sound/voice level is adjusted depending on the output sound/voice level, if a delay occurs in the adjustment process and thus external sound/voice data is stored in a plurality of buffers, the newest external sound/voice data is read and the sound/voice processing is performed using this external sound/voice data. Thus, the sound/voice processing is performed using correct external sound/voice data.

The sound/voice processing apparatus may further include a queue registration unit configured to register the empty buffer in a queue, and the storage processing unit may store the external sound/voice data in the empty buffer registered in the queue.

The sound/voice processing apparatus may further include a newest-data-storing-buffer identifying unit configured to identify a buffer in which the newest external sound/voice data is stored, from buffers in which external sound/voice data is stored, and the external sound/voice data reading unit may read the newest external sound/voice data stored in the buffer identified by the newest-data-storing-buffer identifying unit.

In this implementation of the sound/voice processing apparatus, the buffer in which the newest external sound/voice data is stored is identified, and the newest external sound/voice data is read from this buffer. Thus, the sound/voice processing is performed using correct external sound/voice data.

The sound/voice processing apparatus may further include a retaining unit configured to retain information associated with a storage status of the external sound/voice data in the buffers, and the newest-data-storing-buffer identifying unit may identify the buffer in which the newest external sound/voice data is stored, based on the information retained in the retaining unit as to the storage status of the buffers.

The sound/voice processing apparatus may further include a determination unit configured to determine whether the external sound/voice data stored in the buffer is within a predetermined valid period, and a first excluding unit configured to, if the determination made by the determination unit indicates that the external sound/voice data is not within the valid period, exclude the external sound/voice data from data subjected to the process performed by the external sound/voice processing unit.

In this implementation of the sound/voice processing apparatus, when the external sound/voice data stored in the buffer is not within the valid period, this external sound/voice data is regarded as being unnecessary in the adjustment of the output sound/voice and is discarded so that this external sound/voice data is not subjected to the sound/voice processing. Thus, the sound/voice processing is performed properly.

In the sound/voice processing apparatus, the determination unit may determine whether a time elapsed since the external sound/voice was stored in the buffer is within a predetermined time period.

The sound/voice processing apparatus may further include a second excluding unit configured to exclude external sound/voice data that was stored before the newest external sound/voice data, from data subjected to the process performed by the external sound/voice processing unit.

In the implementation of the sound/voice processing apparatus, the external sound/voice data stored in the buffer before the newest external sound/voice data is regarded as being unnecessary in the adjustment of the output sound/voice and is discarded so that this external sound/voice data is not subjected to the sound/voice processing. Thus, the sound/voice processing is performed properly.

In another aspect of the present embodiments, there is provided a sound/voice processing method including detecting an external sound/voice, storing data of the external sound/voice detected in the external sound/voice detection step into an empty buffer of a plurality of buffers, reading external sound/voice data included in the external sound/voice data stored in the buffers in the storing step, the external sound/voice data to be read being determined depending on a process to be performed using the external sound/voice data, and performing the process using the external sound/voice data read in the external sound/voice data reading step.

In this sound/voice processing method, the external sound/voice data reading step may include reading the newest external sound/voice data of the external sound/voice data stored in the buffers by the storage processing unit, and the external sound/voice processing step may include adjusting an output sound/voice level based on the newest external sound/voice data read in the external sound/voice data reading step.

The sound/voice processing method may further include identifying a buffer in which the newest external sound/voice data is stored, from buffers in which external sound/voice data is stored, and the external sound/voice data reading step may include reading the newest external sound/voice data stored in the buffer identified in the step of identifying the buffer in which the newest external sound/voice data is stored.

The sound/voice processing method may further include determining whether the external sound/voice data stored in the buffer is within a predetermined valid period, and, if the determination made in the determination step indicates that the external sound/voice data is not within the valid period, excluding the external sound/voice data from data subjected to the process performed in the external sound/voice processing step.

The sound/voice processing method may further include excluding external sound/voice data that was stored before the newest external sound/voice data, from data subjected to the process performed in the external sound/voice processing step.

In another aspect of the present embodiments, there is provided a sound/voice processing program executable by a computer serving as a sound/voice processing apparatus, the program including detecting an external sound/voice, storing data of the external sound/voice detected in the external sound/voice detection step into an empty buffer of a plurality of buffers, reading external sound/voice data included in the external sound/voice data stored in the buffers in the storing step, the external sound/voice data to be read being determined depending on a process to be performed using the external sound/voice data, and performing the process using the external sound/voice data read in the external sound/voice data reading step.

In the sound/voice processing program according to the present embodiments, the external sound/voice data reading step may include reading the newest external sound/voice data of the external sound/voice data stored in the buffers by the storage processing unit, and the external sound/voice processing step may include adjusting an output sound/voice level based on the newest external sound/voice data read in the external sound/voice data reading step.

The sound/voice processing program executable by the computer serving as the sound/voice processing apparatus according to the present embodiments may further include the step of identifying a buffer in which the newest external sound/voice data is stored, from buffers in which external sound/voice data is stored, and the external sound/voice data reading step may include reading the newest external sound/voice data stored in the buffer identified in the step of identifying the buffer in which the newest external sound/voice data is stored.

The sound/voice processing program executable by the computer serving as the sound/voice processing apparatus according to the present embodiments may further include determining whether the external sound/voice data stored in the buffer is within a predetermined valid period, and, if the determination made in the determination step indicates that the external sound/voice data is not within the valid period, excluding the external sound/voice data from data subjected to the process performed in the external sound/voice processing step.

The sound/voice processing program executable by the computer serving as the sound/voice processing apparatus according to the present embodiments may further include excluding external sound/voice data that was stored before the newest external sound/voice data, from data subjected to the process performed in the external sound/voice processing step.

As described above, the present embodiments provide a great advantage. That is, external sound/voice data determined depending on the sound/voice processing is read and is subjected to the sound/voice processing using the external sound/voice data. Thus, the sound/voice processing is performed using correct external sound/voice data.

### BRIEF DESCRIPTION OF THE DRAWINGS

FIG. 1 is a diagram illustrating a configuration of a sound/voice processing apparatus according to an exemplary embodiment.

FIG. 2 is a sequence diagram illustrating an operation of a sound/voice processing apparatus.

FIG. 3 is a diagram illustrating an example of a buffer list.

FIG. 4 is a diagram illustrating an example of a process of registering buffers in a queue.

FIG. 5 is a flow chart illustrating an operation of an operation of adjusting a reproduction of sound/voice.

FIG. 6 is a diagram illustrating an example of a process of storing MIC data in a buffer.

FIG. 7 is a diagram illustrating an example of a buffer list.

FIG. 8 is a diagram illustrating an example of a process of reading MIC data from a buffer.

FIG. 9 is a diagram illustrating an example of a process of adjusting a reproduction of sound/voice using MIC data.

FIG. 10 is a diagram illustrating an example of a process of registering buffers in a queue.

FIG. 11 is a diagram illustrating an example of a buffer list.

FIG. 12 is a diagram illustrating an example of a process of storing MIC data in a buffer.

FIG. 13 is a diagram illustrating an example of a buffer list.

FIG. 14 is a diagram illustrating an example of a process of reading MIC data from a buffer.

FIG. 15 is a diagram illustrating an example of a process of adjusting a reproduction of sound/voice using MIC data.

FIG. 16 is a diagram illustrating an example of a process of registering buffers in a queue.

FIG. 17 is a diagram illustrating an example of a buffer list.

FIG. 18 is a sequence diagram illustrating an example of a conventional sound/voice processing.

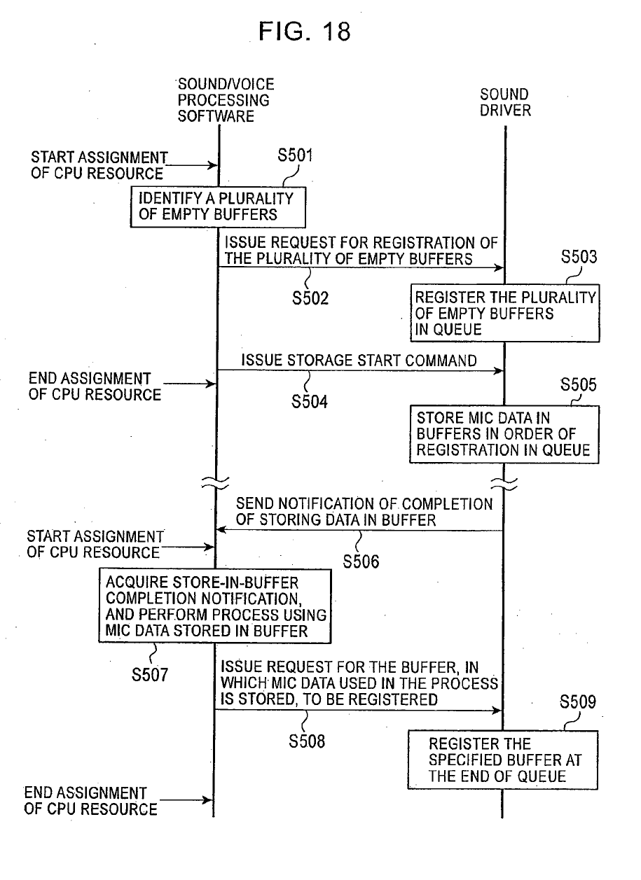

FIG. 19 is a diagram illustrating an example of a conventional process of storing MIC data in a buffer.

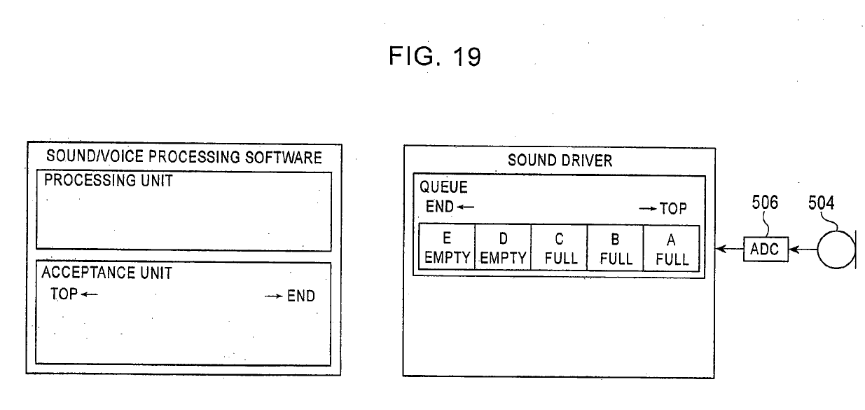

FIG. 20 is a sequence diagram illustrating an example of a conventional sound/voice processing.

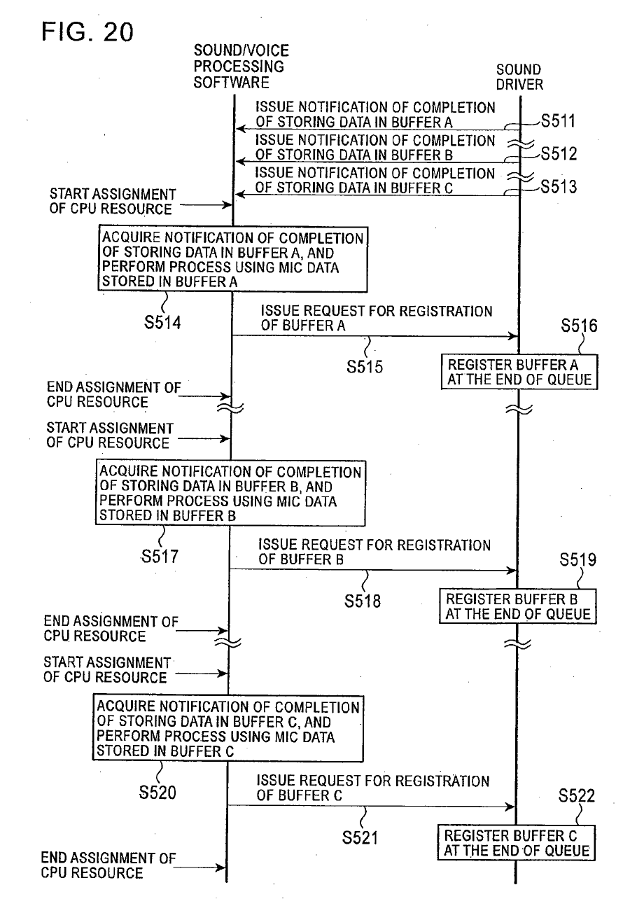

FIG. 21 is a diagram illustrating an example of a conventional sound/voice processing using MIC data.

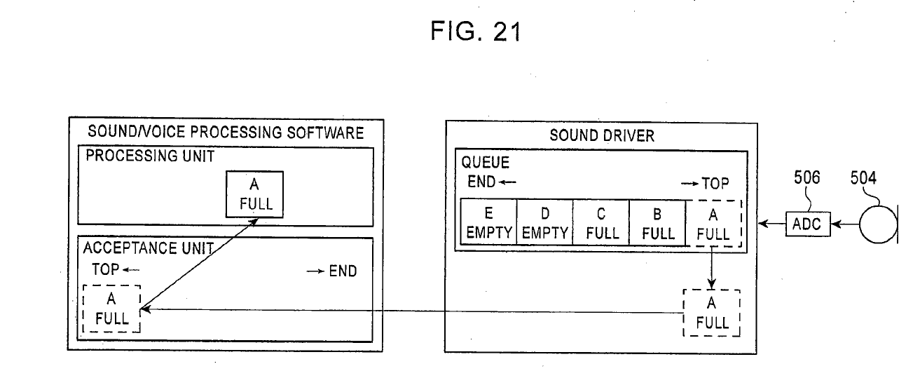

FIG. 22 is a diagram illustrating an example of a conventional sound/voice processing using MIC data.

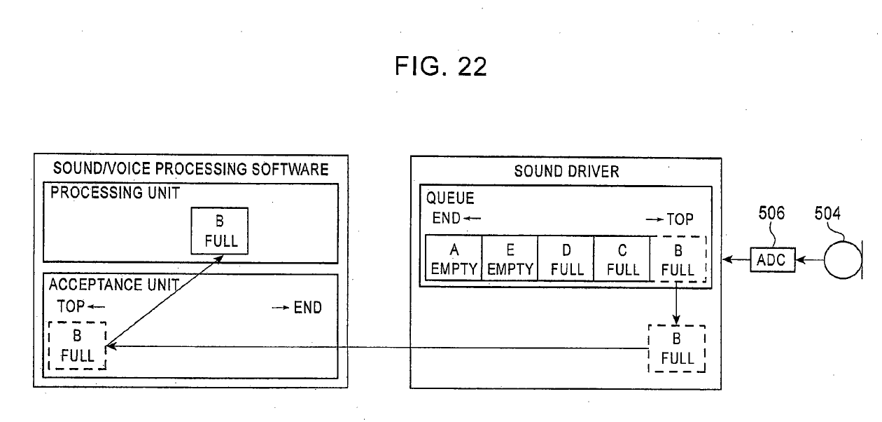

FIG. 23 is a diagram illustrating an example of a conventional sound/voice processing using MIC data.

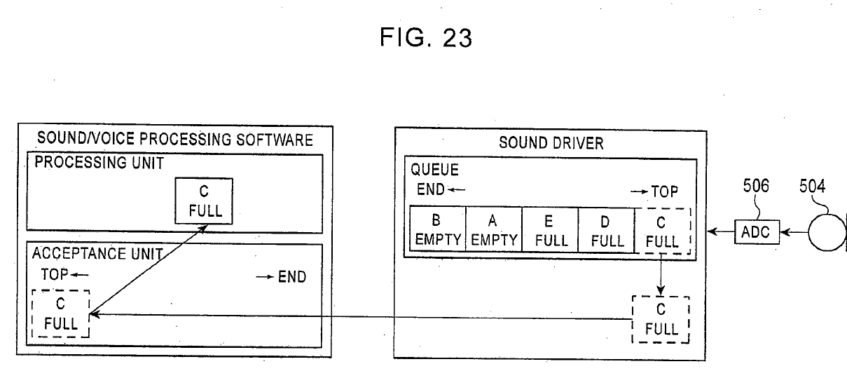

### DESCRIPTION OF THE PREFERRED EMBODIMENTS

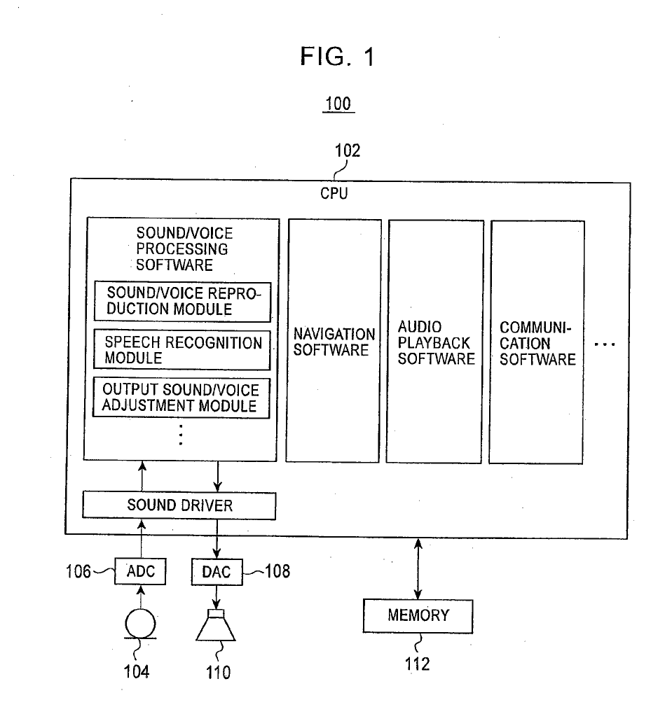

The present embodiments are described in further detail below with reference to embodiments in conjunction with the accompanying drawings. FIG. 1 is a diagram illustrating a configuration of a sound/voice processing apparatus according to an exemplary embodiment. The sound/voice processing apparatus 100 shown in FIG. 1 is implemented, for example, in a navigation apparatus disposed in a vehicle, and includes a CPU 102, a microphone 104, an analog-to-digital converter (ADC) 106, a digital-to-analog converter (DAC) 108, a speaker 110, and a memory 112.

The CPU 102 executes various kinds of application software including sound/voice processing application software (hereinafter referred to simply as sound/voice processing software), sound driver software for inputting/outputting sound/voice data, navigation application software (hereinafter referred to simply as navigation software), audio playback application software (hereinafter referred to simply as audio playback software), communication application software (hereinafter referred to simply as communication software), etc. These pieces of software are stored in the memory 112, and the CPU 102 reads a particular piece of software from the memory 112 as required and executes it. The sound/voice processing software, which is one of these pieces of software, includes a sound/voice reproduction module, a speech recognition module, an output sound/voice adjustment module, etc.

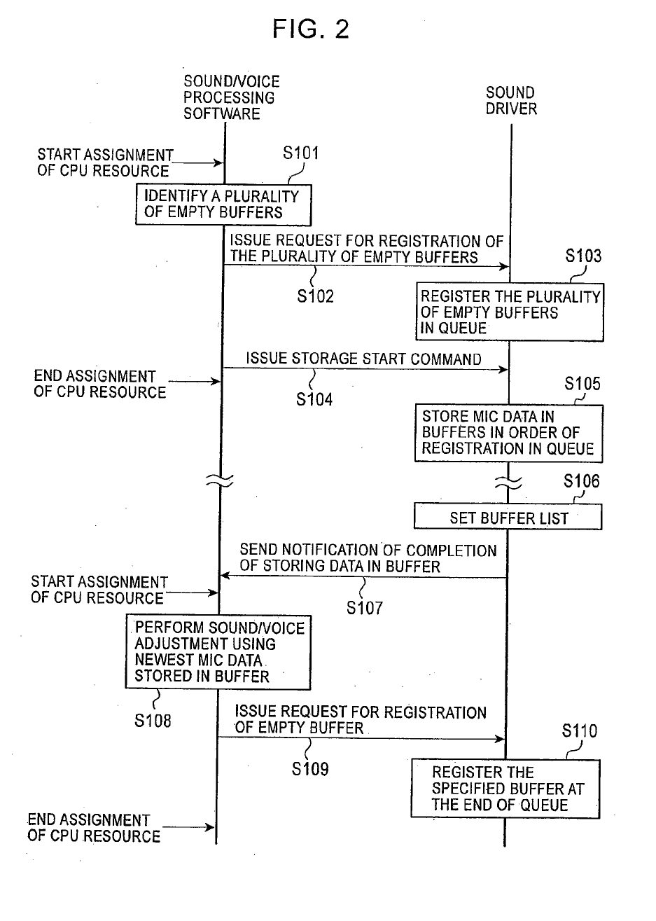

Next, a sound/voice adjustment process performed by the sound/voice processing apparatus 100 is explained. FIG. 2 is a sequence diagram illustrating the sound/voice adjustment process performed by the sound/voice processing apparatus 100. When a resource of the CPU 102 in the sound/voice processing apparatus 100 is assigned to the sound/voice processing software, the sound/voice processing software is executed by the CPU 102.

The CPU 102 executes the sound/voice processing software to identify a plurality of empty buffers for use as storage areas of MIC data from the buffers allocated in the memory 112 (step S101).

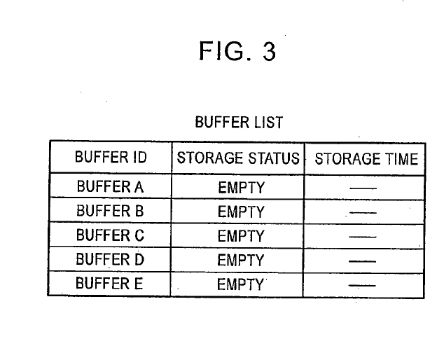

FIG. 3 is a diagram illustrating an example of a list of empty buffers identified as the storage areas of MIC data. In the buffer list shown in FIG. 3, buffer information associated with each buffer is described. The buffer information associated with each buffer includes a buffer ID serving as identification information of the buffer, a storage status of the buffer (“empty” or “full”), and a storage time when MIC data was stored in the buffer. Note that the buffer information associated with each buffer is put in the list in the same order as the order in which the these buffers are registered in a queue (described below). The buffer list is produced by the CPU 102 and stored in the memory 112.

Referring again to FIG. 2, a further explanation is given below. Next, the CPU 102 executes the sound/voice processing software to request the sound driver to register a plurality of empty buffers in a queue (step S102). The registration request includes a buffer ID as identification information identifying an empty buffer. The CPU 102 then executes the sound driver to prepare the queue in which to put empty buffers, and sequentially register the respective empty buffers in the queue in response to the registration request issued in step S102 (step S103).

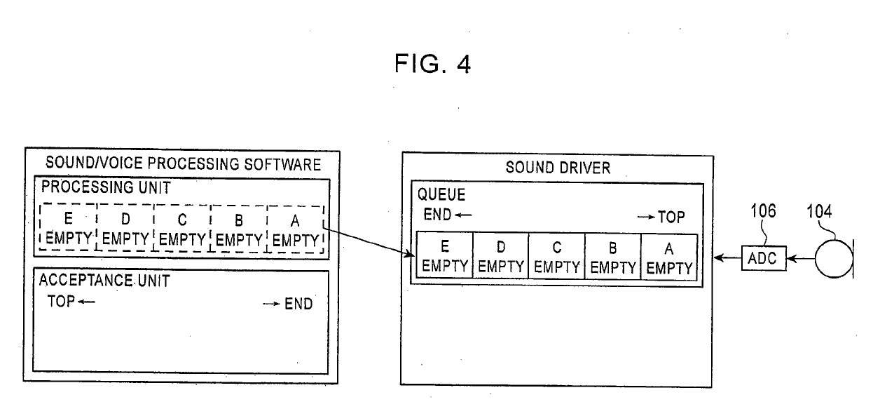

FIG. 4 is a diagram illustrating an example of a process of registering buffers in a queue. If buffers A to E are identified as empty buffers as a result of the execution of the sound/voice processing software, then the sound driver is executed to register these buffers A to E in the queue sequentially starting from the top of the queue.

Referring again to FIG. 2, a further explanation is given below. The CPU 102 then sends a record start command to the sound driver by executing sound/voice processing software (step S104). In response to this record start command, the CPU 102 executes the sound driver to acquire MIC data produced by the ADC 106 by converting an external sound/voice (a sound/voice in a vehicle) detected by a microphone 104 into digital data, and store the acquired MIC data in the empty buffers in the queue sequentially in the same order as the registration order of the buffers (step S105). More specifically, the MIC data is sequentially stored in the buffers registered in the queue in the order from a buffer located closest to the head of the queue to the tail.

After the MIC data has been stored in the buffers, the CPU 102 performs the following process by executing the sound driver. First, the CPU 102 reads a buffer list (buffer list) stored in the memory 112 and sets “full” in the storage status in the buffer information corresponding to the buffer ID of each buffer in which the MIC data is stored, thereby to indicate that the buffer is full. Furthermore, the CPU 102 sets a storage time to indicate the time at which the MIC data was stored (step S106). The CPU 102 then notifies the sound/voice processing software of the completion of storing the data in the buffer (step S107). This notification (notification of completion of storing the data in the buffer) includes the buffer ID of the buffer in which the MIC data is stored.

After the notification of the completion of storing the data in the buffer is sent, the CPU 102 executes the sound/voice processing software to perform the sound/voice adjustment process using the newest MIC data stored in the buffer (step S108).

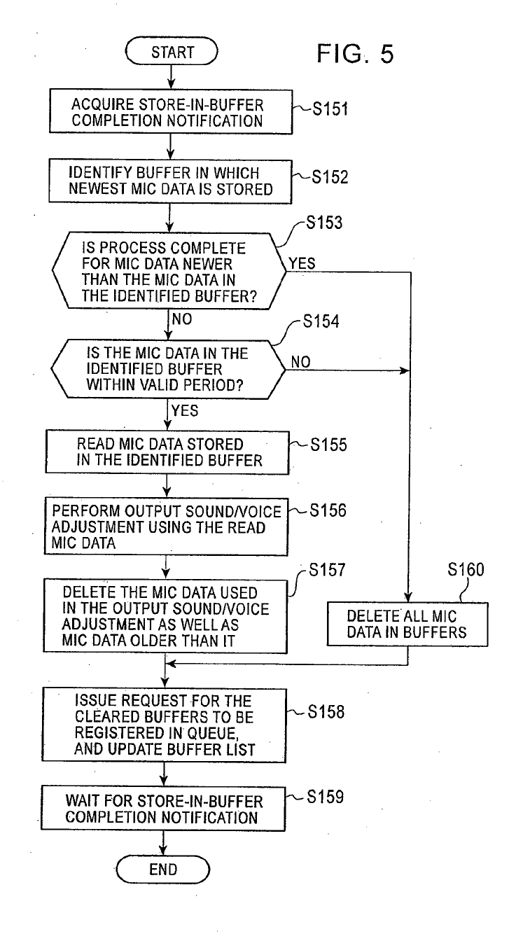

FIG. 5 is a flow chart illustrating the sound/voice adjustment process. The CPU 102 performs the process described below, by executing the sound/voice processing software. First, the CPU 102 acquires a notification of completion of storing data in a buffer (step S151). The CPU 102 then reads the buffer list stored in the memory 112, and identifies a buffer in which newest MIC data is stored. More specifically, the CPU 102 checks the storage status described in buffer information for buffers having lower buffer IDs than the buffer ID included in the notification of completion of storing the data in the buffer. A lowest buffer ID among buffer IDs described in the buffer information with the storage status of “full” is detected, and a buffer corresponding to the detected lowest buffer ID is identified as the buffer in which the newest MIC data is stored (step S152).

Next, the CPU 102 determines whether the sound/voice adjustment process using MIC data newer than the MIC data stored in the buffer identified in S152 has already been completed (S153). More specifically, if, in the buffer list, MIC data stored in a buffer corresponding to buffer information lower than the buffer information corresponding to the buffer in which the newest MIC data is stored was used in the immediately previous sound/voice adjustment process then the CPU 102 makes an affirmative determination in step S153.

If the sound/voice adjustment process using MIC data newer than the MIC data stored in the buffer identified in step S152 is not completed, then the CPU 102 determines whether the newest MIC data in the buffer identified in step S152 is within a valid period (step S154). More specifically, the CPU 102 detects, from the buffer list, a storage time described in the buffer information corresponding to the buffer in which the newest MIC data is stored, and the CPU 102 determines whether the elapsed time from the storage time to the present time is within a predetermined period.

If the newest MIC data is within the valid period, then the CPU 102 reads the newest MIC data stored in the buffer identified in step S152 (step S155), and performs the sound/voice adjustment process using the newest MIC data (S156). More specifically, the CPU 102 detects the level of the external sound/voice based on the newest MIC data, specifies a level of a guidance sound/voice in accordance with the detected level of the external sound/voice, and adjusts digital data of the guidance sound/voice in accordance with the specified level. More specifically, the adjustment is made such that the level of the guidance sound/voice increases with the level of the external sound/voice. The CPU 102 then reproduces the adjusted guidance sound/voice by executing the sound driver. The data of the adjusted guidance sound/voice is converted into analog data by the DAC 108, and the guidance sound/voice is reproduced from the speaker 110 in accordance with the resultant analog data.

Next, the CPU 102 deletes the newest MIC data used in the sound/voice adjustment process performed in step S156 and MIC data older than the newest MIC data from the buffers (step S157). The newest MIC data has already been used in the sound/voice adjustment process performed in step S156, and thus the newest MIC data is no longer necessary. Thus, MIC data older than the newest MIC data is also unnecessary in the sound/voice adjustment process performed in real time. Therefore, in step S157 described above, the newest MIC data and the MIC data older than the newest MIC data are deleted from the buffers so that they are no longer subjected to the sound/voice adjustment process.

More specifically, the CPU 102 detects, from the buffer list, the buffer ID described in buffer information corresponding to the buffer in which the newest MIC data is stored, and the CPU 102 deletes the MIC data identified by the buffer ID from the buffer. The CPU 102 further detects, in the buffer list, buffer information higher in level than the buffer information corresponding to the buffer in which the newest MIC data is stored, and determines the detected buffer information as buffer information corresponding to buffers in which MIC data older than the newest MIC data is stored. The CPU 102 then detects buffer IDs described in the determined buffer information, and deletes MIC data from buffers identified by the detected buffer IDs.

Next, the CPU 102 requests the sound driver to register the buffers, which have become empty after the MIC data was deleted in step S157, in the queue, and the CPU 102 updates the buffer list (step S158). More specifically, the CPU 102 detects, in the buffer list, buffer IDs described in buffer information corresponding to the buffers from which the MIC data was deleted in S157, and the CPU 102 issues a registration request including the detected buffer IDs. Furthermore, the CPU 102 updates the buffer information in the buffer list such that the storage status described in buffer information corresponding to each buffer from which the MIC data was deleted in S157 is changed from “full” to “empty”, and the storage time information is deleted. The CPU 102 then moves the buffer information corresponding to the buffers, from which the MIC data was deleted in S157, to the end of the buffer list.

After the request for registration of the empty buffers in the queue is issued and the buffer list is updated, the CPU 102 waits to acquire a notification of completion of storing data in a buffer (step S159). Thereafter, the processing flow returns to step S151 to repeat the above-described process from step S151 of acquiring a notification of completion of storing data in a buffer.

On the other hand, in a case where it is determined in step S153 that a sound/voice adjustment process using MIC data newer than the MIC data stored in the buffer identified in step S152 has already been completed for some reason, the CPU 102 deletes MIC data in all buffers (step S160). The reason for this is as follows. If the sound/voice adjustment process using MIC data newer than the MIC data stored in the buffer identified in S152 has already been completed, then it can be concluded that the MIC data stored in any buffer is older than the MIC data used in the sound/voice adjustment process, and thus these MIC data are no longer necessary in the sound/voice adjustment process performed in real time. Thus, in step S160 described above, all MIC data stored in the buffers are deleted from the buffers.

Also in a case where it is determined in step S154 that the newest MIC data is not within the valid period, the CPU 102 deletes all MIC data from the buffers (step S160). If the newest MIC data is not within the valid period, then not only the newest MIC data but also any MIC data older than the newest MIC data is not within the valid period, and thus these MIC data are no longer necessary in the sound/voice adjustment process performed in real time. Therefore, in step S160 described above, all MIC data stored in the buffers are deleted from the buffers so that they are no longer subjected to the sound/voice adjustment process.

If all MIC data stored in the buffers were deleted in step S160, then the CPU 102 requests the sound driver to register the buffers, which have become empty after the MIC data were deleted in step S160, in the queue, and the CPU 102 updates the buffer list (step S158). More specifically, the CPU 102 detects, in the buffer list, buffer IDs described in buffer information corresponding to the buffers from which the MIC data was deleted in S160, and the CPU 102 issues a registration request including the detected buffer IDs. Next, the CPU 102 updates the buffer information in the buffer list such that the storage status described in buffer information corresponding to each buffer from which the MIC data was deleted in S160 is changed from “full” to “empty”, and the storage time information is deleted. The CPU 102 then moves the buffer information corresponding to the buffers, from which the MIC data was deleted in S160, to the end of the buffer list.

After the request for registration of the empty buffers in the queue is issued and the buffer list is updated, the CPU 102 waits to acquire a notification of completion of storing data in a buffer (step S159). Thereafter, the processing flow returns to step S151 to repeat the above-described process from step S151 of acquiring a notification of completion of storing data in a buffer.

Referring again to FIG. 2, a further explanation is given below. The CPU 102 then executes the sound/voice processing software to request the sound driver to register an empty buffer in the queue (step S109). The CPU 102 then executes the sound driver to register the requested buffer at the end of the queue (step S110).

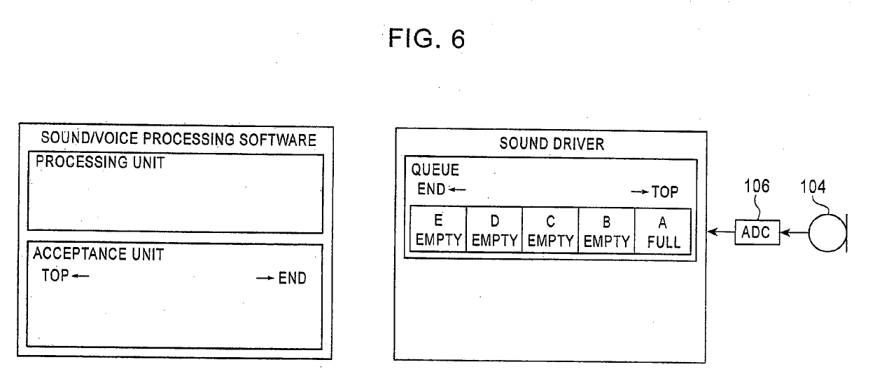

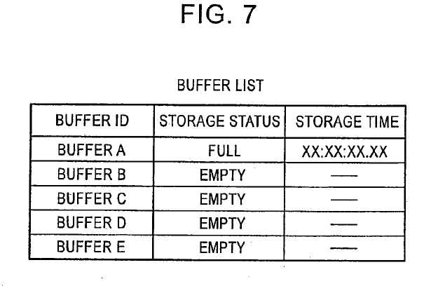

Specific examples of the process from steps S106 to S110 are described below. As a first example, when MIC data is stored only in one buffer, the process is performed as follows. In this case, as shown in FIG. 6, MIC data is stored in a buffer (buffer A in this specific example) registered at the top of the queue in the sound driver. Thus, as shown in FIG. 7, “full” is described as the storage status in the buffer information corresponding to the buffer A located at the top of the buffer list, and a storage time is described. A store-in-buffer completion notification indicating that the storing of the MIC data in the buffer A is complete is issued.

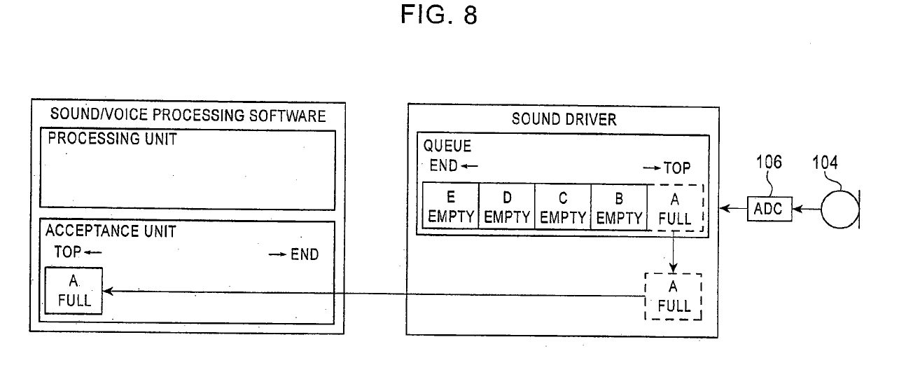

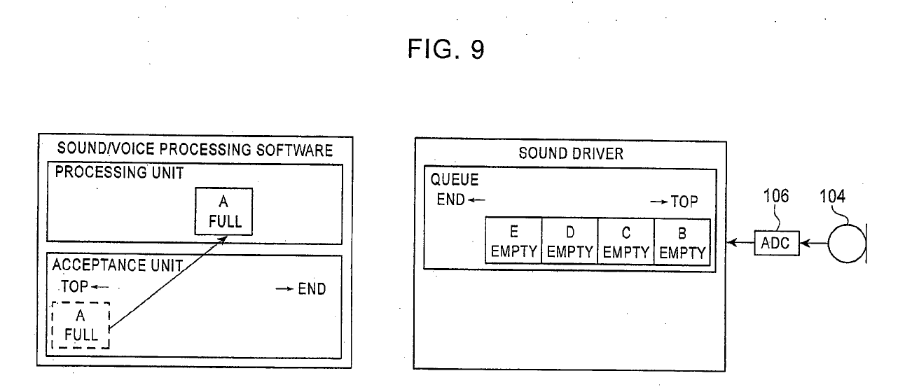

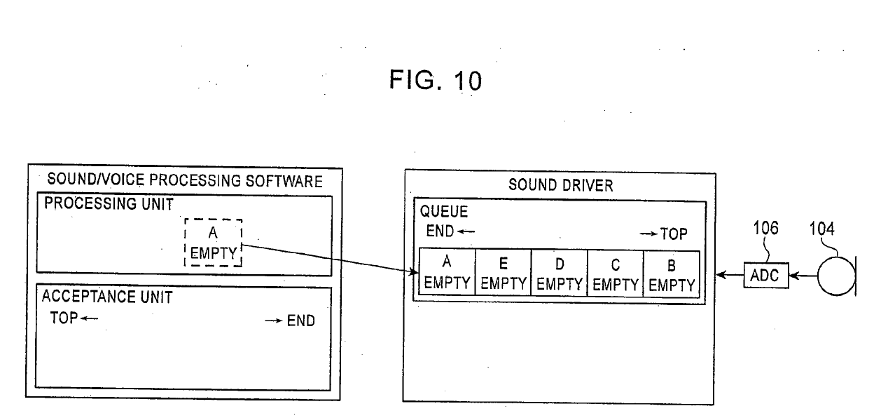

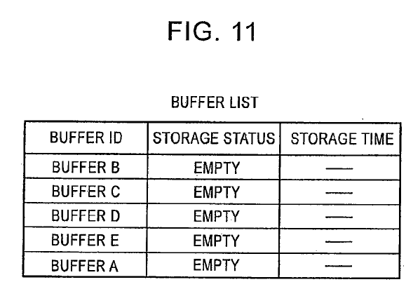

Thereafter, as shown in FIG. 8, the MIC data stored in the buffer A is read and accepted by an accepting unit in the sound/voice processing software. The MIC data is then processed by the processing unit as shown in FIG. 9. If the process is completed, then, as shown in FIG. 10, the MIC data stored in the buffer A is deleted, and the emptied buffer A is registered at the end of the queue. Furthermore, as shown in FIG. 11, the storage status information described in the buffer information corresponding to the buffer A in the buffer list is changed from “full” to “empty”, and the storage time is deleted. The buffer information corresponding to the buffer A is then moved to the end of the buffer list. Thus, the information described in the buffer list is managed so as to correctly indicate the registration status of buffers in the queue and the storage status thereof.

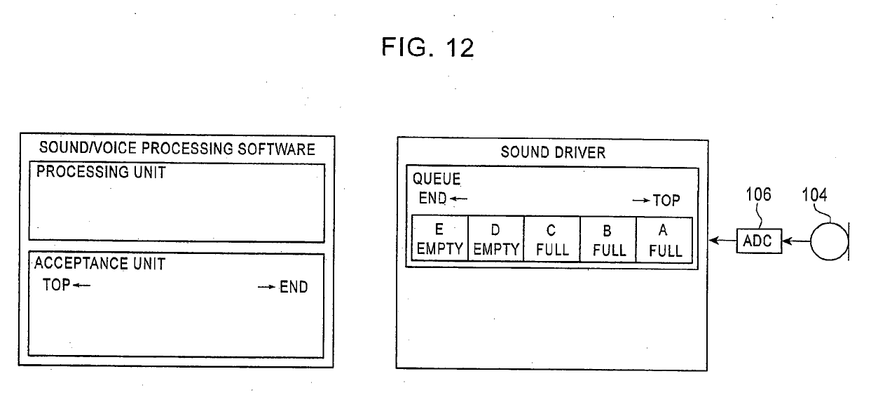

Next, the process is explained below for a case where a delay occurs in execution of the sound/voice processing software and thus MIC data is stored in a plurality of buffers. In this case, as shown in FIG. 12, MIC data is stored sequentially in a plurality of buffers (buffers A to C in this specific example) starting from a buffer located at the top of the queue in the sound driver. Note that, among the MIC data stored in these buffers A to C, the MIC data stored in the buffer C is the newest.

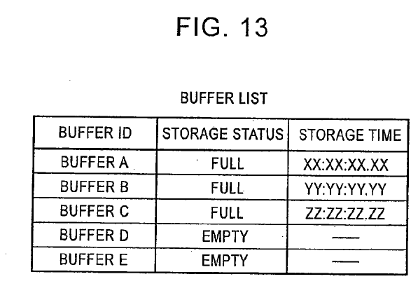

In this case, as shown in FIG. 13, the storage status in the buffer information in the buffer list is set to “full” for the buffers A to C, and storage times are set for these buffers. A store-in-buffer completion notification is then issued to indicate that the storing of MIC data in the buffers A to C is complete.

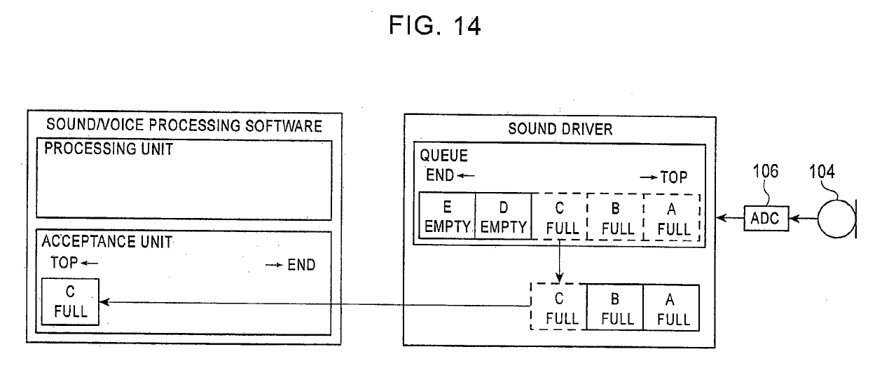

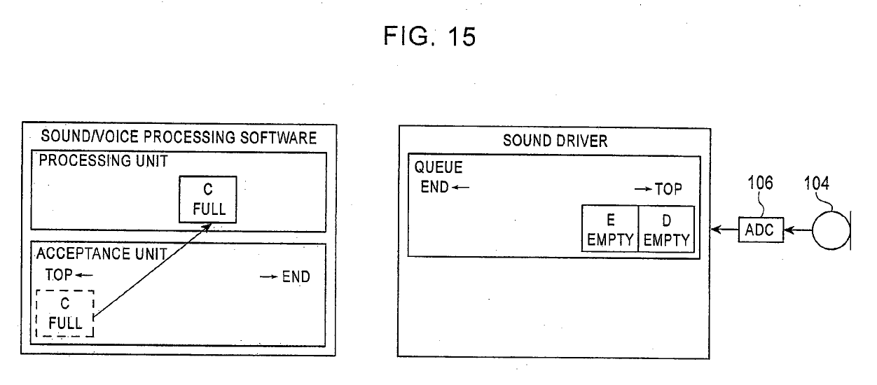

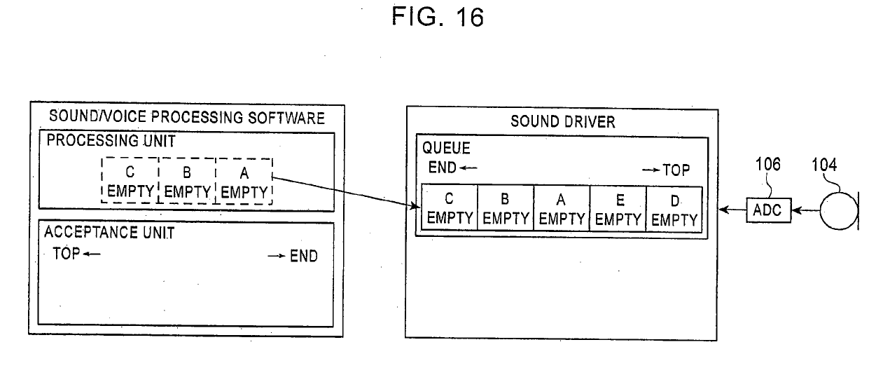

Thereafter, as shown in FIG. 14, of the MIC data stored in the buffers A to C, the newest MIC data stored in the buffer C is read and accepted by the accepting unit of the sound/voice processing software. The MIC data is then processed by the processing unit as shown in FIG. 15. If the process is completed, as shown in FIG. 16, the newest MIC data stored in the buffer C used in the process is deleted, and the MIC data older than the newest MIC data is deleted from the buffers A and B. The emptied buffers A to C are then registered at the end of the queue.

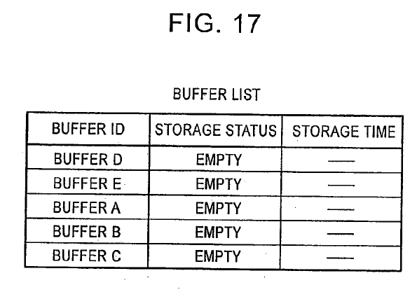

The storage status described in the buffer information corresponding to the buffer C in the buffer list is changed from “full” to “empty”, and the storage time is deleted. The buffer information corresponding to the buffer A and that corresponding to the buffer B, which are higher in level than the buffer information corresponding to the buffer C are moved as well as the buffer information corresponding to the buffer C to the end of the buffer list (see FIG. 17). Thus, the information described in the buffer list is managed so as to correctly indicate the registration status of buffers in the queue and the storage status thereof.

As described above, in the sound/voice processing apparatus 100 according to the present embodiment, when a delay occurs in execution of the sound/voice processing software and thus MIC data is stored in a plurality of buffers, newest MIC data of all MIC data stored in the plurality of buffers is read and the sound/voice adjustment process is performed using this newest MIC data. Thus, even when MIC data is stored in a plurality of buffers, the sound/voice adjustment process is performed properly in real time using the newest MIC data, unlike the conventional technique in which the sound/voice adjustment process is performed by using MIC data sequentially in order from oldest to newest.

The sound/voice processing apparatus 100 according to the present embodiment is capable of correctly identifying a buffer in which newest MIC data is stored, based on the buffer list indicating the order in which buffers are stored in the queue, the status of the buffers in terms of storing MIC data, and the time at which MIC data was stored in each buffer. Based on the buffer list, the sound/voice processing apparatus 100 is also capable of correctly determining whether the MIC data stored in each buffer is within the valid period.

Furthermore, in the sound/voice processing apparatus 100 according to the present embodiment, if MIC data stored in a buffer is determined as being not within the valid period or as being older than the newest MIC data used in the sound/voice adjustment process, then this MIC data is regarded as being unnecessary in the sound/voice adjustment process and is deleted from the buffer thereby achieving high-efficiency use of the buffer.

In the embodiments described above, when MIC data is older than the newest MIC data used in the sound/voice adjustment process, this MIC data is regarded as being unnecessary in the sound/voice adjustment process and is deleted. Alternatively, the MIC data may not be deleted and may be used in the sound/voice adjustment process. In this case, the CPU 102 performs the process described below instead of steps S155 to S157 shown in FIG. 5.

The CPU 102 reads newest MIC data from a buffer identified as storing the newest MIC data, as well as MIC data older than this newest MIC data. More specifically, the CPU 102 detects buffer information at a higher level in the buffer list than buffer information corresponding to the buffer in which the newest MIC data and identifies the detected buffer information as that corresponding to buffers in which MIC data older than the newest MIC data is stored. The CPU 102 then extracts a buffer ID of the buffer from the identified buffer information and reads the MIC data stored in the buffer indicated by the buffer ID.

The CPU 102 then performs the sound/voice adjustment process using the read newest MIC data as well as the MIC data older than the newest MIC data. More particularly, the CPU 102 detects the average external sound/voice level based on the newest MIC data and the MIC data older than the newest MIC data, determines the optimum level of the guidance sound/voice depending on the detected average external sound/voice level, and corrects the guidance sound/voice level according to the determined optimum level. The CPU 102 then produces guidance sound/voice data with the corrected sound/voice level by executing the sound driver. The corrected guidance sound/voice data is then converted into analog form by the DAC 108 and a guidance sound/voice is reproduced from the speaker 110 according to the analog guidance sound/voice data.

Thereafter, the CPU 102 deletes the MIC data used in the sound/voice adjustment process, i.e., the newest MIC data and the MIC data older than the newest MIC data, from the buffers. More specifically, the CPU 102 checks buffer information described in the buffer list to detect the buffer ID corresponding to the buffer in which the newest MIC data, and deletes the MIC data stored in the buffer identified by the detected buffer ID. Furthermore, the CPU 102 checks buffer information described in the buffer list to detect buffer IDs in buffer information at higher levels than the buffer information corresponding to the buffer in which the newest MIC data is stored, and the CPU 102 deletes MIC data stored in the buffers identified by the detected buffer IDs.

Thereafter, the process is performed in a similar manner to the previous examples. That is, the CPU 102 requests the sound driver to register, in the queue, the buffers that have become empty as a result of deletion of MIC data. The CPU 102 then updates the buffer list.

In the embodiments described above, MIC data that is out of the valid period is deleted without being used in the sound/voice adjustment process. Alternatively, such MIC data may be used in the sound/voice adjustment process.

In the embodiments described above, the storage status of MIC data is managed using the buffer list (list structure). Alternatively, the storage status of MIC data may be managed using other structures such as a stack structure.

As described above, the sound/voice processing apparatus, the sound/voice processing method, and the sound/voice processing program according to the present invention make it possible to perform sound/voice processing using external sound/voice data in a more proper manner, and are useful in many applications such as a sound/voice processing apparatus or the like.

While there has been illustrated and described what is at present contemplated to be preferred embodiments of the present invention, it will be understood by those skilled in the art that various changes and modifications may be made, and equivalents may be substituted for elements thereof without departing from the true scope of the invention. In addition, many modifications may be made to adapt a particular situation to the teachings of the invention without departing from the central scope thereof. Therefore, it is intended that this invention not be limited to the particular embodiments disclosed, but that the invention will include all embodiments falling within the scope of the appended claims.

What is claimed is:

1. A sound/voice processing apparatus comprising:
a plurality of buffers;
an external sound/voice detector configured to detect an external sound/voice;
a storage processing unit configured to store data of the external sound/voice detected by the external sound/voice detector into an empty buffer of the plurality of buffers;
an external sound/voice data reading unit configured to read external sound/voice data included in the external sound/voice data stored in the buffers by the storage processing unit, the external sound/voice data to be read being determined depending on a sound/voice adjustment process to be performed using the external sound/voice data; and
an external sound/voice processing unit configured to perform the sound/voice adjustment process using the external sound/voice data read by the external sound/voice data reading unit.

2. The sound/voice processing apparatus according to claim 1, wherein
the external sound/voice data reading unit reads the newest external sound/voice data of the external sound/voice data stored in the buffers by the storage processing unit; and
the external sound/voice processing unit adjusts a sound/voice level based on the newest external sound/voice data read by the external sound/voice data reading unit.

3. The sound/voice processing apparatus according to claim 2, further comprising a queue registration unit configured to register the empty buffer in a queue,
wherein the storage processing unit stores the external sound/voice data in the empty buffer registered in the queue.

4. The sound/voice processing apparatus according to claim 2, further comprising a newest-data-storing-buffer identifying unit configured to identify a buffer in which the newest external sound/voice data is stored, from buffers in which external sound/voice data is stored,
wherein the external sound/voice data reading unit reads the newest external sound/voice data stored in the buffer identified by the newest-data-storing-buffer identifying unit.

5. The sound/voice processing apparatus according to claim 4, further comprising a retaining unit configured to retain information associated with a storage status of the external sound/voice data in the buffers,
wherein the newest-data-storing-buffer identifying unit identifies the buffer in which the newest external sound/voice data is stored, based on the information retained in the retaining unit as to the storage status of the buffers.

6. The sound/voice processing apparatus according to claim 2, further comprising
a determination unit configured to determine whether the external sound/voice data stored in the buffer is within a predetermined valid period; and
a first excluding unit configured to, if the determination made by the determination unit indicates that the external sound/voice data is not within the valid period, exclude the external sound/voice data from data subjected to the process performed by the external sound/voice processing unit.

7. The sound/voice processing apparatus according to claim 6, wherein the determination unit determines whether a time elapsed since the external sound/voice was stored in the buffer is within a predetermined time period.

8. The sound/voice processing apparatus according to claim 2, further comprising a second excluding unit configured to exclude external sound/voice data that was stored before the newest external sound/voice data, from data subjected to the sound/voice adjustment process performed by the external sound/voice processing unit.

9. A sound/voice processing method comprising:
detecting an external sound/voice;
storing data of the external sound/voice detected into an empty buffer of a plurality of buffers;
reading external sound/voice data included in the external sound/voice data stored in the buffers, the external sound/voice data to be read being determined depending on a sound/voice adjustment process to be performed using the external sound/voice data; and
performing the sound/voice adjustment process using the external sound/voice data read from the buffers.

10. The sound/voice processing method according to claim 9, wherein
reading the external sound/voice data includes reading the newest external sound/voice data of the external sound/voice data stored in the buffers by the storage processing unit; and
performing the sound/voice adjustment process using the external sound/voice includes adjusting a sound/voice level based on the newest external sound/voice data read from the buffers.

11. The sound/voice processing method according to claim 10, further comprising:
determining whether the external sound/voice data stored in the buffer is within a predetermined valid period; and
if the determination made indicates that the external sound/voice data is not within the valid period, excluding the external sound/voice data from data subjected to the sound/voice adjustment process.

12. The sound/voice processing method according to claim 9, further comprising identifying a buffer in which the newest external sound/voice data is stored, from buffers in which external sound/voice data is stored,
wherein reading the external sound/voice data includes reading the newest external sound/voice data stored in the buffer identified.

13. The sound/voice processing method according to claim 10, further comprising excluding external sound/voice data that was stored before the newest external sound/voice data, from data subjected to the sound/voice adjustment process.

14. A sound/voice processing program executable by a computer serving as a sound/voice processing apparatus, the program including:
detecting an external sound/voice;
storing data of the external sound/voice detected into an empty buffer of a plurality of buffers;
reading external sound/voice data included in the external sound/voice data stored in the buffers, the external sound/voice data to be read being determined depending on a sound/voice adjustment process to be performed using the external sound/voice data; and
performing the sound/voice adjustment process using the external sound/voice data read from the buffers.

15. The sound/voice processing program executable by the computer serving as the sound/voice processing apparatus according to claim 14, wherein
reading the external sound/voice data includes reading the newest external sound/voice data of the external sound/voice data stored in the buffers by the storage processing unit; and
performing the sound/voice adjustment process using the external sound/voice includes adjusting a sound/voice level based on the newest external sound/voice data read from the buffers.

16. The sound/voice processing program executable by the computer serving as the sound/voice processing apparatus according to claim 14, further comprising identifying a buffer in which the newest external sound/voice data is stored, from buffers in which external sound/voice data is stored,
wherein reading the external sound/voice data includes reading the newest external sound/voice data stored in the buffer identified in which the newest external sound/voice data is stored.

17. The sound/voice processing program executable by the computer serving as the sound/voice processing apparatus according to claim 14, the program further including:
determining whether the external sound/voice data stored in the buffer is within a predetermined valid period; and
if the determination made indicates that the external sound/voice data is not within the valid period, excluding the external sound/voice data from data subjected to the sound/voice adjustment process.

18. The sound/voice processing program executable by the computer serving as the sound/voice processing apparatus according to claim 14, the program further including excluding external sound/voice data that was stored before the newest external sound/voice data, from data subjected to the sound/voice adjustment process.
